(19) United States
(12) Patent Application Publication
(10) Pub. No.: US 2022/0280982 A1
(43) Pub. Date: Sep. 8, 2022

(54) TOOL CLEANING STATION

(71) Applicant: Mazor Robotics Ltd., Caesarea (IL)

(72) Inventors: Yonatan Ushpizin, Glil Yam (IL); Royi Altman, Herzliya (IL); Arik Asaf Levy, Herzliya (IL); Ido Zucker, Tel Aviv (IL)

(21) Appl. No.: 17/190,283

(22) Filed: Mar. 2, 2021

(51) Int. Cl. B08B 1/04; B08B 3/02; B08B 1/00

(52) U.S. Cl. CPC B08B 1/04; B08B 3/02; B08B 1/002

(57) ABSTRACT

A tool cleaning station may include a housing. The housing may comprise a first end and a second end; an interior space; a tool aperture disposed between the first end and the second end and in communication with the interior space; a fluid aperture in fluid communication with a fluid source and in communication with the interior space; and a drainage aperture in communication with the interior space. The station may also include a first brush rotatably disposed in the interior space and secured between the first end and the second end and the first brush may have a first axis. The station may also include a second brush rotatably disposed in the interior space and secured between the first end and the second end and the second brush may have a second axis parallel to and offset from the first axis.

### FIELD

The present technology generally relates to tool cleaning, and relates more particularly to a tool cleaning station for surgical tools.

### BACKGROUND

Surgical tools may be used by a robot, surgeon, or other medical provider in carrying out a surgical procedure. The tool(s) may be used multiple times throughout the surgical procedure. In between uses, the tool(s) may be stored in a tray.

### SUMMARY

Example aspects of the present disclosure include:

A tool cleaning station according to at least one embodiment of the present disclosure comprises a housing comprising a first end and a second end opposite the first end; an interior space; a tool aperture disposed between the first end and the second end and in communication with the interior space, the tool aperture configured to receive a tool; a fluid aperture in fluid communication with a fluid source, the fluid aperture in communication with the interior space; and a drainage aperture in communication with the interior space; a first brush rotatably disposed in the interior space and secured between the first end and the second end, the first brush having a first axis; and a second brush rotatably disposed in the interior space and secured between the first end and the second end, the second brush having a second axis parallel to and offset from the first axis.

Any of the aspects herein, the tool aperture defines a third axis, and the third axis extends between and is substantially perpendicular to the first and second axes.

Any of the aspects herein, wherein the fluid aperture and drainage aperture are positioned such that fluid entering via the fluid aperture passes through at least one of the first and second brushes before exiting via the drainage aperture.

Any of the aspects herein, further comprising: a sensor for sensing a tool in the interior space.

Any of the aspects herein, further comprising: a motor configured to rotate the first brush and the second brush, wherein the motor rotates the first brush and the second brush when the sensor senses the tool in the interior space.

Any of the aspects herein, further comprising: a pump, wherein the pump supplies fluid from the fluid source to the interior space via the fluid aperture when the sensor senses the tool in the interior space.

Any of the aspects herein, further comprising: a fluid depository in communication with the interior space via the drainage aperture, the fluid depository configured to receive spent fluid; and a vacuum source configured to apply a suction force to the interior space, and wherein the vacuum source applies the suction force to the interior space via the drainage aperture when the sensor senses the tool in the interior space.

Any of the aspects herein, wherein the fluid source supplies at least one of air or saline.

Any of the aspects herein, wherein the housing further includes a tool aperture cover disposed on the tool aperture and movable between an open position and a closed position, the tool aperture cover biased to the closed position.

Any of the aspects herein, further comprising: a drive mechanism for automatically opening the tool aperture cover.

Any of the aspects herein, wherein the first brush and the second brush rotate in opposite directions.

A tool cleaning station according to at least one embodiment of the present disclosure comprises a housing defining an interior space accessible via a tool aperture, a fluid aperture, and a drainage aperture; a first brush rotatably connected to the housing and extending through the interior space, the first brush having a first axis; and a second brush rotatably connected to the housing and extending through the interior space, the second brush having a second axis parallel to and offset from the first axis.

Any of the aspects herein, wherein each of the first brush and the second brush rotate and the fluid aperture supplies fluid for a predetermined period of time.

Any of the aspects herein, wherein a notification is communicated when the predetermined period of time has lapsed.

Any of the aspects herein, wherein the drainage aperture is in communication with a fluid depository and a vacuum source, the fluid depository configured to receive spent fluid, the vacuum source configured to apply a suction force to the interior space, and wherein the vacuum source applies the suction force to the interior space via the drainage aperture when the sensor senses the tool in the interior space.

Any of the aspects herein, wherein the housing comprises a tool aperture cover configured to selectively close the tool aperture.

Any of the aspects herein, further comprising a fluid jet nozzle disposed in the fluid aperture, the fluid jet nozzle configured to supply a pressurized fluid to the interior space, wherein the fluid jet is steerable to direct the pressurized fluid.

A system for cleaning a tool according to at least one embodiment of the present disclosure comprises a tool cleaning station comprising a housing having a tool aperture and an interior space, a first brush disposed in the interior space, a second brush disposed in the interior space opposite the second brush, and a sensor configured to sense a tool in the interior space; at least one processor; and a memory storing instructions for execution by the at least one processor that, when executed, cause the at least one processor to: cause the first brush and the second brush to rotate when the sensor senses the tool in the interior space, and cause the first brush and the second brush to stop rotating when the sensor does not sense the tool in the interior space.

Any of the aspects herein, wherein the tool cleaning station further comprises a fluid aperture in communication with a fluid source and the interior space, a pump configured to supply the fluid source to the interior space, a drainage aperture in communication with a fluid depository and the interior space, the fluid depository configured to receive spent fluid, and a vacuum source configured to apply a suction force to the interior space.

Any of the aspects herein, wherein the memory stores additional instructions for execution by the at least one processor that, when executed, further cause the at least one processor to: cause the pump to supply the fluid to the interior space from the fluid source via the fluid aperture when the sensor senses the tool in the interior space, and cause the vacuum source to apply a suction force to the interior space via the drainage aperture when the sensor senses the tool in the interior space.

Any of the aspects herein, wherein the memory stores additional instructions for execution by the at least one processor that, when executed, further cause the at least one processor to: cause a robotic arm to insert a tool into the tool aperture, and cause the robotic arm to remove the tool from the tool aperture after a predetermined period of time.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1A is an isometric view of a tool cleaning station according to at least one embodiment of the present disclosure;

FIG. 1B is a front schematic cross-section view along the line A-A of the tool cleaning station shown in FIG. 1A according to at least one embodiment of the present disclosure;

FIG. 1C is a side schematic cross-section view along the line B-B of the tool cleaning station shown in FIG. 1A according to at least one embodiment of the present disclosure;

FIG. 2 is a block diagram of a system according to at least one embodiment of the present disclosure; and

FIG. 3 is a flowchart according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device and/or a medical device.

In one or more examples, the described methods, processes, and techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10× Fusion processors; Apple A11, A12, A12X, A12Z, or A13 Bionic processors; or any other general purpose microprocessors), graphics processing units (e.g., Nvidia GeForce RTX 2000-series processors, Nvidia GeForce RTX 3000-series processors, AMD Radeon RX 5000-series processors, AMD Radeon RX 6000-series processors, or any other graphics processing units), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

Surgical tool(s) used by a surgeon during a surgical procedure are typically washed prior to being placed back into a tray. Leftover tissue and/or bodily fluids may cause the tool to stick to the tray. The wash prevents the tool(s) from adhering or sticking to the tray due to leftover tissue that may be stuck on the tool(s).

During a robot-assisted surgical procedure or an autonomous robotic surgical procedure, the surgical robot may need to exchange tools (e.g., using an automatic tool changer) during the course of the procedure. Embodiments of the present disclosure provide systems, devices, and methods for cleaning the tool(s) after each use and prior to the tool(s) being returned to a toolbox, tray, or other location. The present disclosure thus provides for the washing of robotically manipulated surgical tools such as a drill, a tapper, a screw inserter, and others. A sterile washing system is provided, which may be located within a work volume of the robot to allow for insertion of tool(s) therein for washing of the same prior to placing the tool(s) back into a toolbox or tray.

Embodiments of the present disclosure provide technical solutions to one or more of the problems of (1) cleaning surgical tool(s) during a robotically assisted or conducted surgical procedure, (2) storing surgical tool(s) for reuse during a surgical procedure, (3) increasing patient safety and reducing operating time during a surgical procedure by ensuring surgical tool(s) are substantially free of debris and operable for reuse during a surgical procedure.

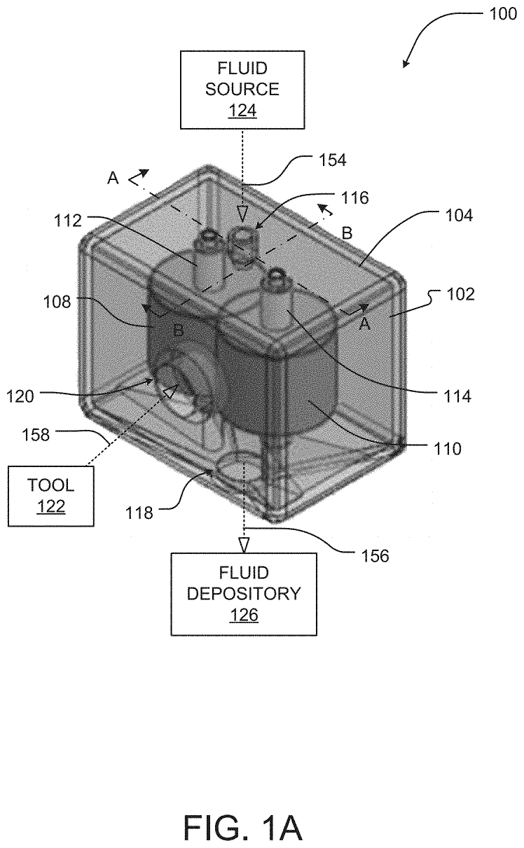

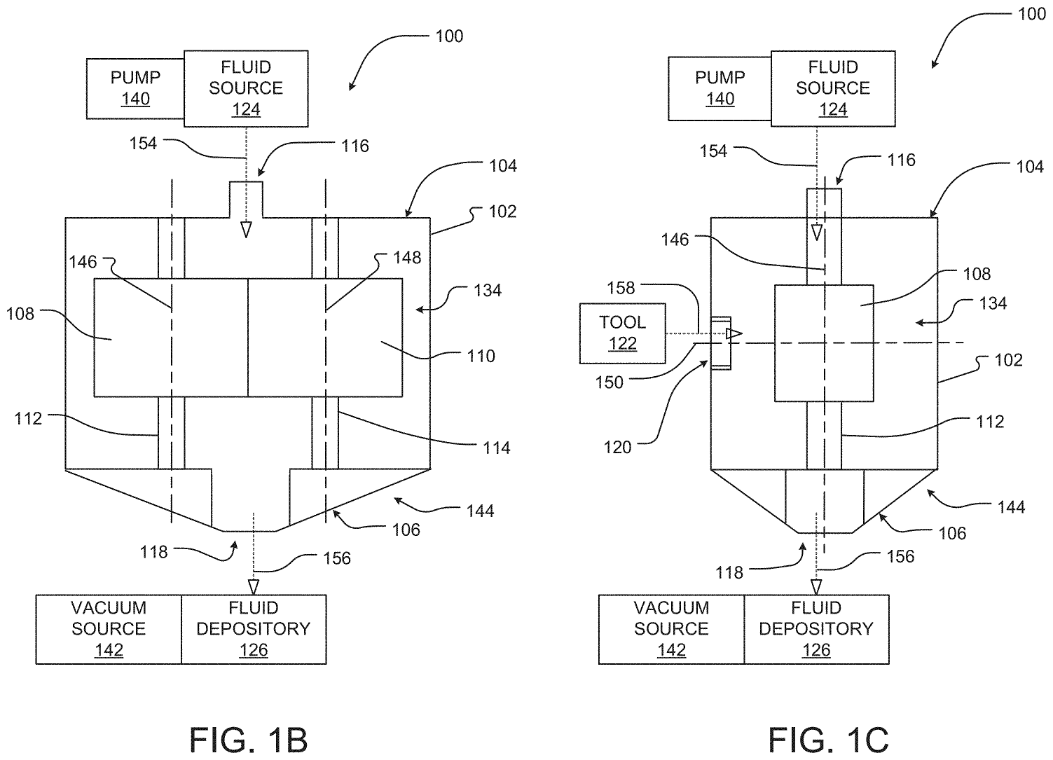

Turning first to FIGS. 1A-1C, an isometric view of a tool cleaning station 100, a front schematic cross-section view of the station 100, and a side schematic cross-section view of the station 100 are respectively shown. The station includes a housing 102 (shown transparently for clarity in FIG. 1A) having a first end 104, a second end 106 opposite the first end 104, and an interior space 134. The housing 102 includes a fluid aperture 116, a drainage aperture 118 and a tool aperture 120, of which each aperture 116, 118, 120 is in fluid communication with the interior space 134. In the illustrated embodiment, the fluid aperture 116 is disposed on the housing 102 at the first end 104, the drainage aperture 118 is disposed on the housing 102 at the second end 106 and the tool aperture 120 is disposed on the housing 102 between the first end 104 and the second end 106. In other embodiments, the fluid aperture 116, the drainage aperture 118, and/or the tool aperture 120 may be disposed on any portion of the housing 102.

In the illustrated embodiment, the housing 102 is rectangular shaped and includes an angled extension 144, visible in FIGS. 1B-1C, at the second end 106. The angled extension 144 (which may be or define, for example, a sloped bottom surface) may help direct spent fluid (and any tissue or other particles entrained therein) to the drainage aperture 118 during use of the tool cleaning station 100. In other embodiments, the housing 102 may be any shape and may include any number of extensions or may not include any extensions. The housing 102 may be formed from any material such as aluminum, titanium, steel, rubber, silicone, or the like.

In the illustrated embodiment, the fluid aperture 116 is shaped as a circle. In other embodiments, the fluid aperture 116 may be any shape including a rectangle, a triangle, an oval, or the like. The fluid aperture 116 is in fluid communication with a fluid source 124. The fluid source 124 and the fluid aperture 116 may be connected directly or by a tube or a hose. During use, a fluid may be supplied from the fluid source 124 to the interior space 134 via the fluid aperture 116 in a first direction 154. The fluid may be a gas (e.g., oxygen, air, carbon dioxide, heliox) or a liquid (e.g., water, saline, or another irrigant). The fluid source 124 may be integrated into the housing 102, may be removably secured to the housing 102, or may be disposed separately from the housing 102.

In some embodiments, the station 100 may include a pump 140, shown in FIGS. 1B and 1C, configured to pump the fluid from the fluid source 124 to the interior space 134. The station 100 may include one pump, two pumps, or more than two pumps. The pump 140 may be any kind of pump 140 including a centrifugal pump or a positive displacement pump. The pump 140 may also be submersible inside the fluid source 124 or may be disposed outside of the fluid source 124. In some embodiments, the pump 140 may be driven by a motor. In other embodiments, the pump 140 may be a hand pump and manually operated. In some embodiments, the station 100 may not include a pump 140 and may instead deliver the fluid using gravity, for example.

In some embodiments, the fluid aperture 116 may include a fluid jet nozzle (not shown) disposed in the fluid aperture. The fluid jet nozzle may be configured to supply a pressurized fluid to the interior space. The fluid may be pressurized by the pump 140. The fluid jet nozzle may be steerable (whether manually or automatically) to direct the pressurized fluid. For example, the fluid jet nozzle may be steerable to direct the pressurized fluid to a certain portion of a tool 122, or to continuously move a stream of pressurized fluid along the tool 122 (or along an expected position of the tool 122). In some embodiments, the station 100 may include one, two, or more than two fluid jet nozzles. In embodiments where the station 100 includes two or more fluid jet nozzles, each nozzle may be steerable, none of the nozzles may be steerable, or some of the nozzles may be steerable. In some embodiments, the fluid jet nozzle(s) may be disposed on the first rod 112 and/or the second rod 114 so as to provide a fluid stream that pushes anatomical material out of the brushes. This may aid in cleaning the tool 122 and may also prevent debris or particles from becoming lodged in the first brush 108 and/or the second brush 110.

In the illustrated embodiment, the drainage aperture 118 is shaped as a circle. In other embodiments, the drainage aperture 118 may be any shape including a rectangle, a triangle, an oval, or the like. The drainage aperture 118 is in fluid communication with a fluid depository 126. The drainage aperture 118 and the fluid depository 126 may be connected directly, or by a tube or a hose. During use, spent fluid is drained from the interior space 134 to the fluid depository 126 via the drainage aperture 118 in a second direction 156. In some embodiments, the first direction 154 and the second direction 156 may be the same direction. In other embodiments, the first direction 154 and the second direction 156 may be different directions. The spent fluid may include debris, tissue particles, or the like dislodged from the tool 122. The fluid depository 126 may be integrated into the housing 102, may be removably secured to the housing 102, or may be disposed separately from the housing 102.

In some embodiments, the station 100 may include a vacuum source 142, shown in FIGS. 1B and 1C, configured to apply a suction force to the interior space 134 via the drainage aperture 118. More specifically, the suction force may cause a negative pressure in the interior space 134 to cause a suction of spent fluid from the interior space 134 to the drainage aperture 118. The suction force may be created by, for example, a pump, motor, or other vacuum source operably coupled to the fluid depository. In some embodiments, the station 100 may not include a vacuum source 142 and may instead drain the fluid using gravity, for example.

In the illustrated embodiment, the tool aperture 120 is shaped as a circle. In other embodiments, the tool aperture 120 may be any shape including a rectangle, a triangle, an oval, or the like. In yet other embodiments, the tool aperture 120 may be in the shape of a cross section of the tool 122 so as to be shaped to receive the tool 122. The tool 122 may be inserted into the tool aperture 120 in a third direction 158. In some embodiments, the third direction 158 may be substantially perpendicular to the first direction 154 and/or the section direction 156. In other embodiments, the third direction 158 may be at any angle with respect to the first direction 154 or the second direction 156 or may be the same direction as the first direction 154 or the second direction 156. The tool 122 may by any kind of tool including a drill, a tap, a screw inserter, a brush, or the like. In some embodiments, the tool aperture 120 may include a tool aperture cover (not shown) disposed on the tool aperture 120. In other embodiments, the tool apertures 120 may not include a tool aperture cover.

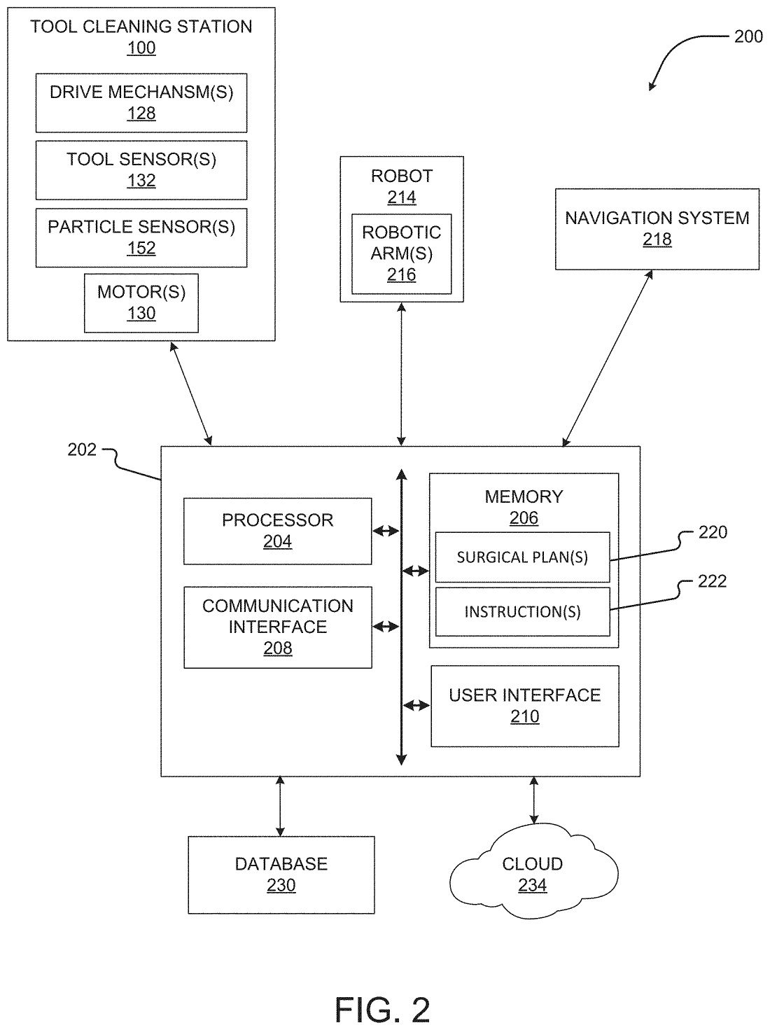

The cover, when included in the tool aperture 120, may be movable between an open position and a closed position and may be configured to selectively close the tool aperture 120. In some embodiments, the cover may be biased to the closed position. In other embodiments, the cover may be biased to the open position. The cover may be biased to the closed position by a spring. The cover may also be manufactured from a resilient material (e.g., rubber, silicone) that may receive a force to push the cover open and may return to the closed position when the force is released. In some embodiments, a drive mechanism such as a drive mechanism 128, shown in FIG. 2, may be configured to automatically open and/or close the cover. In some embodiments, the drive mechanism 128 is a motor. The drive mechanism 128 may be an electric motor, a pneumatic motor, a hydraulic motor, or another type of motor. In some embodiments, the drive mechanism 128 comprises a gear motor. In other embodiments, the drive mechanism 128 comprises any type of motor including an AC brushless motor, a DC brushed motor, a DC brushless motor, a servo motor, or the like.

The station 100 also includes a first brush 108 rotatable on or by a first rod 112 and a second brush 110 rotatable on or by a second rod 114 disposed in the interior space 134. In some embodiments, the station may include one brush or more than two brushes. The first rod 112 and the second rod 114 are each rotatably secured to the housing 102 and are operable to rotate or spin the first brush 108 and the second brush 110, respectively. As described in more detail below, a motor (including any motor described herein or any other motor) may be operably coupled to one or both of the first rod 112 and the second rod 114 to cause rotation thereof. In some embodiments, a single motor may be coupled to the first rod 112, and one or more gears, chains, and/or other force-transmitting devices may be used to transmit rotational force from the first rod 112 to the second rod 114 (or vice versa). In some embodiments, the first brush 108 and the second brush 110 rotate in opposite directions. In other embodiments, the first brush 108 and the second brush 110 rotate in the same direction. As illustrated, the first brush 108 defines a first axis 146 and the second brush 110 defines a second axis 148. The second axis 148 (and thus the second brush 110) is parallel to and offset from the first axis 146. Further, the tool aperture 120 may define a third axis 150, shown in FIG. 1C, that extends between and is substantially perpendicular to the first axis 146 and the second axis 148.

As illustrated in FIG. 1A, the first brush 108 and the second brush 110 have equal diameters and are spaced such that an outer diameter of each of the first brush 108 and the second brush 110 overlap. This overlap may ensure that all surfaces of the tool 122 are contacted by both or one of the first brush 108 and/or the second brush 110 when the tool 122 is inserted into the tool cleaning station 100 via the tool aperture 120. In other embodiments, the diameter of the first brush 108 may be different from the second brush 110. In yet other embodiments, the diameter of the first brush 108 may or may not contact and/or may or may not overlap the diameter of the second brush 110.

In some embodiments, the first brush 108 and the second brush 110 are made from single material such as a sponge or a cleaning pad. In other embodiments, the first brush 108 and the second brush 110 may be made from natural or synthetic fibers of any thickness and any stiffness. In some embodiments, the first brush 108 and the second brush 110 may be made from the same fibers. In other embodiments the first brush 108 may be made from different fibers, may have a different thickness, and/or may have a different stiffness than the second brush 110. In further embodiments, each of the first brush 108 and/or the second brush 110 may be made of two or more different materials. For example, each brush may include both soft fibers and coarse fibers. In the illustrated embodiment, the outer profiles of the first brush 108 and the second brush 110 are cylindrically shaped. In other embodiments, the outer profile of the first brush 108 and/or the second brush 110 may include extensions, depressions, divots, undulations, and/or the like.

During use, a tool 122 may be inserted into the tool aperture 120 and in between the first brush 108 and the second brush 110. As the first brush 108 and the second brush 110 rotate, debris may be dislodged from the tool 122. In some embodiments, a perimeter of the tool aperture 120 may extend into the interior space 136 and act as a guide for the tool 122 to ensure positioning of the tool 122 in between the first brush 108 and the second brush 110. In some embodiments, an internal guide (not illustrated) may extend from the tool aperture 120 towards the first brush 108 and the second brush 110. The internal guide may also include a stop to prevent the tool 122 from contacting an interior wall of the housing (and thus, potentially causing damage to a tip of the tool 122). It will be appreciated that the fluid aperture and the drainage aperture are positioned such that fluid entering via the fluid aperture in the first direction 154 passes through at least one of the first brush 108 or the second brush 110 before exiting via the drainage aperture 118 in the second direction 156.

The station 100 may also include a motor 130, shown in FIG. 2, configured to rotate the first brush 108 and the second brush 110. In some embodiments, the station 100 may include one motor to rotate both the first brush 108 and the second brush 110 (either via a direct connection to each brush 108 and 110 or via a direct connection to one of the brushes 108 and 110 and an indirect connection to the other of the brushes 108 and 110). In other embodiments, the station 100 may include a motor for each of the first brush 108 and the second brush 110. The motor 130 may be an electric motor, a pneumatic motor, a hydraulic motor, or another type of motor. In some embodiments, the motor 130 comprises a gear motor. In other embodiments, the motor 130 comprises any type of motor including an AC brushless motor, a DC brushed motor, a DC brushless motor, a servo motor, or the like.

The station 100 may also include at least one tool sensor 132, shown in FIG. 2, configured to sense when the tool 122 is inserted into or is within the interior space 136. In some embodiments, the station 100 may not include the at least one tool sensor 132. The tool sensor 132 may be any kind of tool sensor 132 for sensing the tool 122. The tool sensor 132 may include one or more or any combination of components that are electrical, mechanical, electro-mechanical, magnetic, electromagnetic, or the like. The tool sensor 132 may include, but is not limited to, one or more of a capacitance proximity sensor, a photoelectric sensor, an ultrasonic sensor, or a laser. In some embodiments, the tool sensor 132 may include a memory for storing sensor data. In still other examples, the tool sensor 132 may output signals (e.g., sensor data) to one or more sources (e.g., the drive mechanism 128, the motor(s) 130, the pump 140, the fluid source 124, the vacuum source 142, or a computing device 202 shown in FIG. 2).

In some examples, the tool sensor 132 may trigger the motor 130 to rotate the first brush 108 and the second brush 110, the pump 140 to supply fluid from the fluid source 124 to the interior space 134, and/or the vacuum source 142 to apply a suction force to the interior space 134 to cause spent fluid and debris to drain from the interior space 134 to the fluid depository 126. The tool sensor 132 may also cause the motor 130, the pump 140, and/or the vacuum source 142 to stop operating when the tool sensor 132 no longer senses the tool 122 in the interior space 134.

The station 100 may also include at least one particle sensor 152, shown in FIG. 2, configured to sense particles in spent fluid exiting the interior space 134. In some embodiments, the particle sensor 152 may be disposed in the drainage aperture 118. In other embodiments, the particle sensor 152 may be disposed in any part of the station 100. The particle sensor 152 may be any kind of particle sensor 152 for sensing particles in the spent fluid. When the spent fluid is substantially free of particles (or other debris), this may indicate that the tool 122 is substantially free of particles, and thus clean. In some embodiments, the particle sensor 152 may generate and transmit a signal to indicate that the tool 122 is clean and to stop operation of the motor 130, the pump 140, the fluid source 124, and/or the vacuum source 142. In some embodiments, the signal may be generated and transmitted based on a predetermined threshold. For example, the signal may be generated and transmitted when the fluid has less than 1 ppm. Additionally, the signal may be generated only after the detected particle count is below a predetermined threshold for a predetermined period of time (e.g., 10 seconds, 30 seconds, 1 minute), to account for the possibility that one or more particles require some time to become dislodged from the tool 122 while the tool 122 is in the station 100.

The particle sensor 152 may include one or more or any combination of components that are electrical, mechanical, electro-mechanical, magnetic, electromagnetic, or the like. The particle sensor 152 may include, but is not limited to, one or more of a capacitance proximity sensor, a photoelectric sensor, an ultrasonic sensor, or a laser. In some embodiments, the particle sensor 152 may include a memory for storing sensor data. In still other examples, the particle sensor 152 may output signals (e.g., sensor data) to one or more sources (e.g., the drive mechanism 128, the motor(s) 130, the pump 140, the fluid source 124, the vacuum source 142, or the computing device 202).

Turning to FIG. 2, a block diagram of a system 200 according to at least one embodiment of the present disclosure is shown. The system 200 may be used to operate a tool cleaning station 100 as described above with respect to FIGS. 1A-1C. The tool cleaning station 100 may be operated automatically or partially automatically (e.g., with assistance and/or input from a surgeon or operator) by the system 200. The system 200 may also be used to carry out one or more other aspects of the method disclosed herein and any similar method.

The system 200 comprises a computing device 202, a robot 214, a navigation system 218, a database 230, and a cloud or other network 234. Systems according to other embodiments of the present disclosure may comprise more or fewer components than the system 200. For example, the system 200 may not include the robot 214, the navigation system 218, one or more components of the computing device 202, the database 230, and/or the cloud 234.

The computing device 202 comprises a processor 204, a memory 206, a communication interface 208, and a user interface 210. Computing devices according to other embodiments of the present disclosure may comprise more or fewer components than the computing device 202.

The processor 204 of the computing device 202 may be any processor described herein or any similar processor. The processor 204 may be configured to execute instructions stored in the memory 206, which instructions may cause the processor 204 to carry out one or more computing steps utilizing or based on data received from the tool cleaning station 100, the robot 214, the navigation system 218, the database 230, and/or the cloud 234.

The memory 206 may be or comprise RAM, DRAM, SDRAM, other solid-state memory, any memory described herein, and/or any other tangible, non-transitory memory for storing computer-readable data and/or instructions. The memory 206 may store information or data useful for completing, for example, any step of the method 300 described herein, or of any other methods. The memory 206 may store, for example, one or more surgical plans 220 and/or one or more sets of instructions 222. Such instructions 222 may, in some embodiments, be organized into one or more applications, modules, packages, layers, or engines. The instructions 222 may cause the processor 204 to manipulate data stored in the memory 206 and/or received from or via the tool cleaning station 100, robot 214, the database 230, and/or the cloud 234.

The computing device 202 may also comprise a communication interface 208. The communication interface 208 may be used for receiving image data or other information from an external source (such as the tool cleaning station 100, the robot 214, the navigation system 218, the database 230, the cloud 234, and/or any other system or component not part of the system 200), and/or for transmitting instructions, images, or other information to an external system or device (e.g., another computing device 202, the robot 214, the navigation system 218, the database 230, the cloud 234, and/or any other system or component not part of the system 200). The communication interface 208 may comprise one or more wired interfaces (e.g., a USB port, an ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 208 may be useful for enabling the device 202 to communicate with one or more other processors 204 or computing devices 202, whether to reduce the time needed to accomplish a computing-intensive task or for any other reason.

The computing device 202 may also comprise one or more user interfaces 210. The user interface 210 may be or comprise a keyboard, mouse, trackball, monitor, television, screen, touchscreen, and/or any other device for receiving information from a user and/or for providing information to a user. The user interface 210 may be used, for example, to receive a user selection or other user input regarding any step of any method described herein. Notwithstanding the foregoing, any required input for any step of any method described herein may be generated automatically by the system 200 (e.g., by the processor 204 or another component of the system 200) or received by the system 200 from a source external to the system 200. In some embodiments, the user interface 210 may be useful to allow a surgeon or other user to modify instructions to be executed by the processor 204 according to one or more embodiments of the present disclosure, and/or to modify or adjust a setting of other information displayed on the user interface 210 or corresponding thereto.

Although the user interface 210 is shown as part of the computing device 202, in some embodiments, the computing device 202 may utilize a user interface 210 that is housed separately from one or more remaining components of the computing device 202. In some embodiments, the user interface 210 may be located proximate one or more other components of the computing device 202, while in other embodiments, the user interface 210 may be located remotely from one or more other components of the computer device 202.

The navigation system 218 may provide navigation for a surgeon and/or a surgical robot during an operation. The navigation system 218 may be any now-known or future-developed navigation system, including, for example, the Medtronic StealthStation™ S8 surgical navigation system or any successor thereof. The navigation system 218 may include one or more cameras or other sensor(s) for tracking one or more reference markers, navigated trackers, or other objects within the operating room or other room in which some or all of the system 200 is located. The one or more cameras may be optical cameras, infrared cameras, or other cameras. In some embodiments, the navigation system may comprise one or more electromagnetic sensors. In various embodiments, the navigation system 218 may be used to track a position and orientation (i.e., pose) of the robot 214 and/or robotic arm 216, and/or one or more surgical tools such as the tool 122 (or, more particularly, to track a pose of a navigated tracker attached, directly or indirectly, in fixed relation to one or more of the foregoing). The navigation system 218 may include a display for displaying one or more images from an external source (e.g., the computing device 202, or other source) or for displaying an image and/or video stream from the one or more cameras or other sensors of the navigation system 218. In some embodiments, the system 200 can operate without the use of the navigation system 218. The navigation system 218 may be configured to provide guidance to a surgeon or other user of the system 200 or a component thereof, to the robot 214, or to any other element of the system 200 regarding, for example, a pose of one or more anatomical elements, whether or not a tool is in the proper trajectory, and/or how to move a tool into the proper trajectory to carry out a surgical task according to a preoperative or other surgical plan such as the surgical plan 220. In some embodiments, the navigation system 218 may be utilized to guide a robot 214 (or to assist in guiding a robot 214) to insert a tool such as a tool 122 into the tool cleaning station 100.

The robot 214 may be any surgical robot or surgical robotic system. The robot 214 may be or comprise, for example, the Mazor X™ Stealth Edition robotic guidance system. The robot 214 may additionally or alternatively be configured to manipulate a surgical tool such as the tool 122 (whether based on guidance from the navigation system 218 or not) to accomplish or to assist with a surgical task. The robot 214 may also be configured to manipulate the surgical tool 122 to insert the tool 122 into the tool cleaning station 100, to remove the tool 122 from the tool cleaning station 100, and/or to store the tool 122 in a tray, tool box, magazine, or other storage container. In some embodiments, the robot 214 may be configured to hold and/or manipulate an anatomical element during or in connection with a surgical procedure. The robot 214 may comprise one or more robotic arms 216. In some embodiments, the robotic arm 216 may comprise a first robotic arm and a second robotic arm, though the robot 214 may comprise more than two robotic arms. In some embodiments, one or more of the robotic arms 216 may be used to hold and/or maneuver the tool 122. Each robotic arm 216 may be positionable independently of the other robotic arm. The robotic arms may be controlled in a single, shared coordinate space, or in separate coordinate spaces.

The robot 214, together with the robotic arm 216, may have, for example, one, two, three, four, five, six, seven, or more degrees of freedom. Further, the robotic arm 216 may be positioned or positionable in any pose, plane, and/or focal point. The pose includes a position and an orientation. As a result, a surgical tool 122, or other object held by the robot 214 (or, more specifically, by the robotic arm 216) may be precisely positionable in one or more needed and specific positions and orientations.

The robotic arm(s) 216 may comprise one or more robotic sensors that enable the processor 204 (or a processor of the robot 214) to determine a precise pose in space of the robotic arm (as well as any object or element held by or secured to the robotic arm).

In some embodiments, reference markers (i.e., navigation markers) may be placed on the robot 214 (including, e.g., on the robotic arm 216), the tool 122, the station 100, or any other object in the surgical space. The reference markers may be tracked by the navigation system 218, and the results of the tracking may be used by the robot 214 and/or by an operator of the system 200 or any component thereof. In some embodiments, the navigation system 218 can be used to track other components of the system (e.g., tool 122 and/or station 100) and the system 200 can operate without the use of the robot 214 (e.g., with the surgeon manually manipulating the one or more tools 122, based on information and/or instructions generated by the navigation system 218, for example).

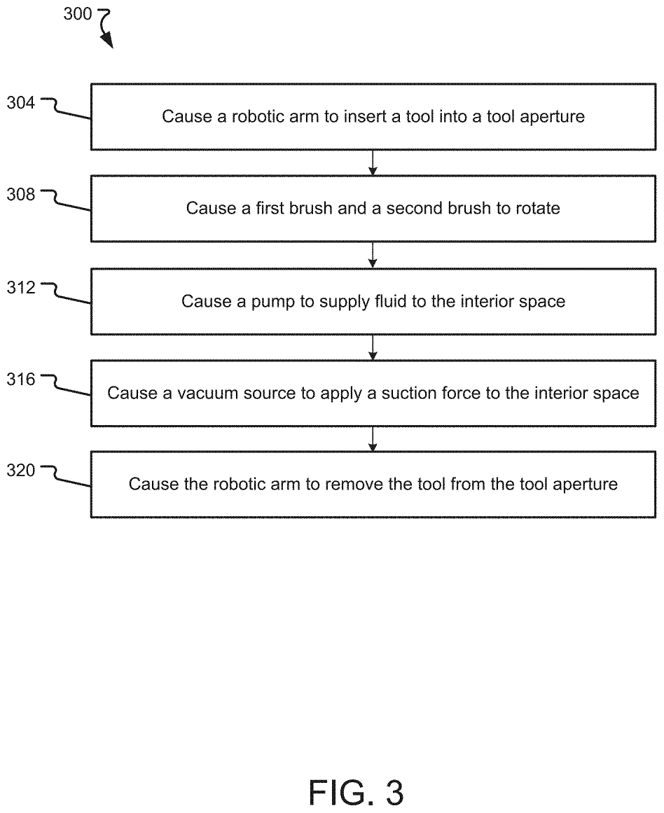

FIG. 3 depicts a method 300 that may be used, for example, to clean a tool using a tool cleaning station.

The method 300 (and/or one or more steps thereof) may be carried out or otherwise performed, for example, by at least one processor. The at least one processor may be the same as or similar to the processor(s) 204 of the computing device 202 described above. The at least one processor may be part of a robot (such as a robot 214) or part of a navigation system (such as a navigation system 218). A processor other than any processor described herein may also be used to execute the method 300. The at least one processor may perform the method 300 by executing instructions such as the instructions 222 stored in a memory such as the memory 206. The instructions may correspond to one or more steps of the method 300 described below.

The method 300 comprises causing a robotic arm to insert a tool into a tool aperture of a tool cleaning station (step 304). The robotic arm may be the same as or similar to the robotic arm 216 described above; the tool may be the same as or similar to the tool 122 described above; the tool aperture may be the same as or similar to the tool aperture 120 described above; and the tool cleaning station may be the same as or similar to the tool cleaning station 100 described above. As described above, the tool cleaning station may include a housing such as the housing 102 having an interior space such as the interior space 134. The station may also include a fluid aperture such as the fluid aperture 116, a drainage aperture such as the drainage aperture 118 and a tool aperture such as the tool aperture 120. Each of the fluid aperture, the drainage aperture, and the tool aperture may be in communication with the interior space.

In some embodiments, the robotic arm may automatically insert the tool into the tool aperture and the interior space (e.g., prior to switching from one tool to another). Alternatively, a surgeon or user may instruct the robotic arm to insert the tool. In some embodiments, the surgeon or user may manually insert the tool. In some embodiments, the robotic arm may insert the tool into the tool aperture based on a surgical plan such as the surgical plan 220. In some embodiments, instructions such as the instructions 222 may be generated based on the surgical plan and transmitted to the robotic arm to cause the robotic arm to insert the tool into the tool aperture. In other embodiments, the robotic arm may insert the tool into the tool aperture upon input from a surgeon or a user (which may be received from, for example, a user interface such as the user interface 210).

The method 300 also comprises causing a first brush and a second brush of the tool cleaning station to rotate when the tool is in the interior space (step 308). The first brush may be the same as or similar to the first brush 108 described above and the second brush may be the same as or similar to the second brush 110 described above. In some embodiments, the first brush and the second brush may rotate when a tool sensor such as the tool sensor 132 senses the tool in the interior space. The first brush and the second brush may stop rotating when the sensor no longer senses the tool in the interior space. Alternatively, the first brush and the second brush may stop rotating when the sensor senses that fluid exiting the drainage valve is substantially particle-free using a particle sensor such as the particle sensor 152.

In other embodiments, the first brush and the second brush may rotate based on a step in the surgical plan. For example, instructions such as the instructions 222 may be generated based on the step in the surgical plan and transmitted to the station to cause the first brush and the second brush to rotate after the robotic arm has inserted the tool into the tool aperture. In still other embodiments, the first brush and the second brush may rotate for a predetermined period of time beginning when the sensor senses the tool in the interior space. The predetermined period of time may be based on the surgical plan or input received from a surgeon or operator by, for example, the user interface.

The method 300 also comprises causing a pump to supply fluid to the interior space (step 312). The pump may be the same as or similar to the pump 140 described above. The pump may supply fluid from the fluid source to the interior space via the fluid aperture. The fluid may be a gas (e.g., oxygen, air, carbon dioxide, heliox) or a liquid (e.g., water, saline, or another irrigant). In some embodiments, the pump supplies fluid to the interior space when the tool sensor senses the tool in the interior space. The pump may stop supplying the fluid to the interior space when the sensor no longer senses the tool in the interior space. Alternatively, the pump may stop supplying fluid to the interior space when the sensor senses that fluid exiting the drainage valve is substantially particle-free using the particle sensor.

In other embodiments, the pump may supply the fluid to the interior space based on a step in the surgical plan. For example, instructions such as the instructions 222 may be generated based on the step in the surgical plan and transmitted to cause the pump to supply the fluid to the interior space after the robotic arm has inserted the tool into the tool aperture. In still other embodiments, the pump may supply the fluid to the interior space for a predetermined period of time beginning when the sensor senses the tool in the interior space. The predetermined period of time may be based on the surgical plan or input received from a surgeon or operator by, for example, the user interface.

The step 312 may also comprise supplying a first fluid to the interior space and a second fluid to the interior space after the first fluid. The first fluid may be, for example, a cleaning solution to dislodge particles from the tool. The second fluid may be, for example, a sterilizing solution for sterilizing the tool. In some embodiments, the step 312 may comprise sequentially supplying more than two types of fluids to the interior space.

The method 300 also comprises cause a vacuum source to apply a suction force to the interior space (step 316). The vacuum source may be the same as or similar to the vacuum source 142 described above. The vacuum source may stop applying a suction when the sensor no longer senses the tool in the interior space. Alternatively, the vacuum source may stop applying a suction when the sensor senses that fluid exiting the drainage valve is substantially particle-free using the particle sensor. As yet further alternatives, the vacuum source may stop applying a suction when (or shortly after) the pump stops supplying fluid to the interior space, or when fluid ceases to enter a fluid depository such as the fluid depository 126.

In other embodiments, the vacuum source may apply a suction based on a step in the surgical plan. For example, instructions such as the instructions 222 may be generated based on the step in the surgical plan and transmitted to the station to cause the vacuum source to apply a suction after the robotic arm has inserted the tool into the tool aperture. In still other embodiments, the vacuum source may apply a suction for a predetermined period of time beginning when the sensor senses the tool in the interior space. The predetermined period of time may be based on the surgical plan or input received from a surgeon or operator by, for example, the user interface.

The method 300 also comprises causing the robotic arm to remove the tool from the tool aperture (step 320). The robotic arm may automatically remove the tool from the tool aperture. Alternatively, a surgeon or user may instruct the robotic arm to remove the tool. In some embodiments, the surgeon or user may manually remove the tool. Alternatively, the robotic arm may remove the tool from the tool aperture when the sensor senses that fluid exiting the drainage valve is substantially particle-free using the particle sensor.

In other embodiments, the robotic arm may remove the tool based on a step in the surgical plan. For example, instructions such as the instructions 222 may be generated based on the step in the surgical plan and transmitted to the station to cause the robotic arm to remove the tool from the tool aperture. In still other embodiments, the robotic arm may remove the tool after a predetermined period of time. In further embodiments, the robotic arm may remove the tool after a predetermined period of time beginning when the sensor senses the tool in the interior space. The predetermined period of time may be based on the surgical plan or input received from a surgeon or operator by, for example, the user interface.

The robotic arm may also place the tool in a tray, toolbox, magazine, or storage compartment for later use or sterilization. The robotic arm may also pick up and support a new tool during the procedure and repeat the steps 304-320 with the new tool after use of the new tool. It will be appreciated that the robotic arm may pick up multiple tool(s), switch tool(s), operate any tool(s), and insert any tool(s) into the cleaning station using the method 300.

It will be appreciated that the steps 308, 312, and 316 may occur simultaneously. For example, when the tool sensor senses a tool in the tool aperture, the first brush and the second brush may rotate, the pump may supply a fluid to the interior space, and a vacuum source may apply a suction force to the interior space. As the fluid moves from the fluid aperture to the drainage aperture, the fluid may pass through one of the first brush and/or the second brush and dislodge particles or debris stuck in the tool (and/or the brush). Further, as the fluid moves from the fluid aperture to the drainage aperture, the first brush and the second brush rotate to dislodge particles or debris stuck in the tool and the vacuum source causes the spent fluid and the dislodged particles or debris to be suctioned from the interior space (and possibly from the first brush, the second brush, and/or the tool) through the drainage aperture and to a fluid depository such as the fluid depository 126.

It will also be appreciated that the steps 308, 312, and 316 may be staggered or two of the steps 308, 312, and 316 may occur simultaneously prior to one of the steps 308, 312, and 316. For example, the pump may supply fluid to the interior space and the vacuum source may be activated prior to rotating the first brush and the second brush to lubricate and/or clean the first brush, the second brush, and/or the tool. It will also be appreciated that the steps 308, 312, and 316 may cease operations simultaneously, may cease operations sequentially, or two of the steps 308, 312, and 316 may cease operations prior to one of the steps 308, 312, and 316. The steps 308, 312, and 316 may cease operations when the predetermined period of time has lapsed, when the sensor has sensed that the tool is no longer in the interior space, when the particle sensor has sensed that the spent fluid is substantially particle-free, or when the tool is otherwise indicated to be substantially particle-free. Further, a notification may be generated and communicated to the robotic arm or a surgeon or user. The notification may be machine readable and transmitted to the robotic arm or human readable and communicated to the surgeon or user via the user interface. For example, in embodiments where a surgeon or user manually inserts the tool into the tool aperture, the notification may alert the surgeon or the user when the tool is substantially particle-free or when the predetermined period of time has lapsed.

The present disclosure encompasses embodiments of the method 300 that comprise more or fewer steps than those described above, and/or one or more steps that are different than the steps described above.

As noted above, the present disclosure encompasses methods with fewer than all of the steps identified in FIG. 3 (and the corresponding description of the method 300), as well as methods that include additional steps beyond those identified in FIG. 3 (and the corresponding description of the method 300). The present disclosure also encompasses methods that comprise one or more steps from one method described herein, and one or more steps from another method described herein. Any correlation described herein may be or comprise a registration or any other correlation.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A tool cleaning station comprising:
a housing comprising:
a first end and a second end opposite the first end;
an interior space;
a tool aperture disposed between the first end and the second end and in communication with the interior space, the tool aperture configured to receive a tool;
a fluid aperture in fluid communication with a fluid source, the fluid aperture in communication with the interior space; and
a drainage aperture in communication with the interior space;
a first brush rotatably disposed in the interior space and secured between the first end and the second end, the first brush having a first axis; and
a second brush rotatably disposed in the interior space and secured between the first end and the second end, the second brush having a second axis parallel to and offset from the first axis.

2. The station of claim 1, the tool aperture defines a third axis, and the third axis extends between and is substantially perpendicular to the first and second axes.

3. The station of claim 1, wherein the fluid aperture and drainage aperture are positioned such that fluid entering via the fluid aperture passes through at least one of the first and second brushes before exiting via the drainage aperture.

4. The station of claim 1, further comprising:
a sensor for sensing a tool in the interior space.

5. The station of claim 4, further comprising:
a motor configured to rotate the first brush and the second brush, wherein the motor rotates the first brush and the second brush when the sensor senses the tool in the interior space.

6. The station of claim 4, further comprising:
a pump, wherein the pump supplies fluid from the fluid source to the interior space via the fluid aperture when the sensor senses the tool in the interior space.

7. The station of claim 4, further comprising:
a fluid depository in communication with the interior space via the drainage aperture, the fluid depository configured to receive spent fluid; and
a vacuum source configured to apply a suction force to the interior space, and wherein the vacuum source applies the suction force to the interior space via the drainage aperture when the sensor senses the tool in the interior space.

8. The station of claim 1, wherein the housing further includes a tool aperture cover disposed on the tool aperture and movable between an open position and a closed position, the tool aperture cover biased to the closed position.

9. The station of claim 8, further comprising:
a drive mechanism for automatically opening the tool aperture cover.

10. The station of claim 1, wherein the first brush and the second brush rotate in opposite directions.

11. A tool cleaning station comprising:
a housing defining an interior space accessible via a tool aperture, a fluid aperture, and a drainage aperture;
a first brush rotatably connected to the housing and extending through the interior space, the first brush having a first axis; and
a second brush rotatably connected to the housing and extending through the interior space, the second brush having a second axis parallel to and offset from the first axis.

12. The station of claim 11, wherein each of the first brush and the second brush rotate and the fluid aperture supplies fluid for a predetermined period of time.

13. The station of claim 12, wherein a notification is communicated when the predetermined period of time has lapsed.

14. The station of claim 11, wherein the drainage aperture is in communication with a fluid depository and a vacuum source, the fluid depository configured to receive spent fluid, the vacuum source configured to apply a suction force to the interior space, and wherein the vacuum source applies the suction force to the interior space via the drainage aperture when the sensor senses the tool in the interior space.

15. The station of claim 11, wherein the housing comprises a tool aperture cover configured to selectively close the tool aperture.

16. The station of claim 11, further comprising a fluid jet nozzle disposed in the fluid aperture, the fluid jet nozzle configured to supply a pressurized fluid to the interior space, wherein the fluid jet is steerable to direct the pressurized fluid.

17. A system for cleaning a tool comprising:
a tool cleaning station comprising a housing having a tool aperture and an interior space, a first brush disposed in the interior space, a second brush disposed in the interior space opposite the second brush, and a sensor configured to sense a tool in the interior space;
at least one processor; and
a memory storing instructions for execution by the at least one processor that, when executed, cause the at least one processor to:
cause the first brush and the second brush to rotate when the sensor senses the tool in the interior space, and
cause the first brush and the second brush to stop rotating when the sensor does not sense the tool in the interior space.

18. The system of claim 17, wherein the tool cleaning station further comprises a fluid aperture in communication with a fluid source and the interior space, a pump configured to supply the fluid source to the interior space, a drainage aperture in communication with a fluid depository and the interior space, the fluid depository configured to receive spent fluid, and a vacuum source configured to apply a suction force to the interior space.

19. The system of claim 18, wherein the memory stores additional instructions for execution by the at least one processor that, when executed, further cause the at least one processor to:
cause the pump to supply the fluid to the interior space from the fluid source via the fluid aperture when the sensor senses the tool in the interior space, and
cause the vacuum source to apply a suction force to the interior space via the drainage aperture when the sensor senses the tool in the interior space.

20. The system of claim 17, wherein the memory stores additional instructions for execution by the at least one processor that, when executed, further cause the at least one processor to:
cause a robotic arm to insert a tool into the tool aperture, and
cause the robotic arm to remove the tool from the tool aperture after a predetermined period of time.
